(19) United States
(12) Patent Application Publication
(10) Pub. No.: US 2026/0044692 A1
(43) Pub. Date: Feb. 12, 2026

(54) SMART CARD AND READER USING ULTRA-WIDE BAND COMMUNICATION

(71) Applicant: Microchip Technology Incorporated, Chandler, AZ (US)

(72) Inventor: Valentin Stoia, Bucharest (RO)

(73) Assignee: Microchip Technology Incorporated, Chandler, AZ (US)

(21) Appl. No.: 18/905,252

(22) Filed: Oct. 3, 2024

Related U.S. Application Data
(60) Provisional application No. 63/681,316, filed on Aug. 9, 2024.

(51) Int. Cl. G06K 7/10

(52) U.S. Cl. CPC G06K 7/10366

(57) ABSTRACT

A system and method for a passive ultra-wide band (UWB) communication-enabled contactless smart card is disclosed. A method may include capturing a card ID advertisement from a smart card. The method may also include verifying a card ID from the card ID advertisement. The method may additionally include pairing with the smart card and activating a pairing light. The method may further include establishing a UWB communication channel with the smart card.

### PRIORITY

This application claims priority to U.S. Provisional Ser. No. 63/681,316 filed Aug. 9, 2024, the contents of which are hereby incorporated in their entirety.

### TECHNICAL FIELD

The present disclosure relates to a contactless smart card, and, in particular, a passive smart card and reader using ultra-wide band (UWB) communication.

### BACKGROUND

Ultra-wideband (UWB) uses a low energy level for short-range, high-bandwidth communication over a portion of the radio spectrum. UWB devices send out short pulses of radio waves. By measuring the time it takes for the pulses to travel to and from another device, UWB can calculate the distance between the two devices with high accuracy. UWB may have a communication range of tens to hundreds of meters.

Contactless smart cards are used for a variety of use cases such as security badges, payment cards, electronic identification, and electronic ticketing. The smart cards typically have embedded microchips to enable communication with a reader device (e.g., a point-of-sale terminal or access reader at a door or gate) without physical contact. The smart card and reader device typically communicate using radio frequency identification (RFID) or near field communication (NFC) communication protocols. A smart card typically is very close (e.g., less than approximately eight inches) to the reader to establish communication.

Smart wearables have been used as a replacement for contactless smart cards. However, the level of security achievable with a smart wearable depends on the manufacturer of the smart wearable and the settings of the operating system running on the smart wearable. Additionally, smart wearables cannot function as a passive device.

### SUMMARY OF THE INVENTION

Aspects provide systems and methods for a passive smart card and reader using ultra-wide band (UWB) communication. Examples of the present disclosure may include an apparatus. The apparatus may include a contact pad and a pairing light. The apparatus may additionally include an ultra-wide band (UWB) transceiver and a control circuit. The control circuit may be to activate the UWB transceiver when the contact pad is activated by a user. The control circuit may also be to activate the pairing light to display a light pattern. Additionally, the control circuit may be to establish a UWB communication channel with a reader.

In combination with any of the above examples, the apparatus may also include a solar cell to power the control circuit.

In combination with any of the above examples, the apparatus may also include a card ID advertisement displayed on a surface.

In combination with any of the above examples, the apparatus may also include a display. The control circuit may be to display, using the display, a first card ID advertisement at a first time and a second card ID advertisement at a second time.

In combination with any of the above examples, the control circuit may also be to receive a signal from the reader indicating the light pattern to display. The light pattern may be to display corresponds to a second light pattern displayed on the reader.

In combination with any of the above examples, the control circuit may also be to deactivate the UWB transceiver when the contact pad is deactivated by the user.

Alone or in combination with any of the above examples, examples of the present disclosure may include an apparatus with a control circuit. The control circuit may be to instruct a camera to capture a card ID advertisement from a smart card and verify a card ID from the card ID advertisement. The control circuit may also be to pair with the smart card using an ultra-wide band (UWB) transceiver. The control circuit may additionally be to activate a pairing light to display a light pattern and establish a UWB communication channel with the smart card.

In combination with any of the above examples, the control circuit may also be to triangulate a location of the smart card based on signal strength from a UWB antenna and verify the location of the smart card corresponds to a location of the captured card ID advertisement.

In combination with any of the above examples, the control circuit may also be to verify the location of the smart card corresponds to a location of the captured card ID advertisement.

In combination with any of the above examples, the control circuit may also be to activate a light to illuminate an area proximate to the smart card.

In combination with any of the above examples, the control circuit may also be to detect the smart card and activate the light based on the detection.

In combination with any of the above examples, the control circuit may also be to instruct the camera to capture the card ID advertisement based on a motion detected by a proximity sensor.

In combination with any of the above examples, the control circuit may also be to send a signal to the smart card to activate a second pairing light, the second pairing light located on the smart card.

In combination with any of the above examples, the pairing light and the second pairing light may display corresponding light patterns.

Alone or in combination with any of the above examples, examples of the present disclosure may include a method including capturing a card ID advertisement from a smart card. The method may also include verifying a card ID from the card ID advertisement. The method may additionally include pairing with the smart card and activating a pairing light. The method may further include establishing a UWB communication channel with the smart card.

In combination with any of the above examples, the method may include triangulating a location of the smart card and verifying the location of the smart card corresponds to a location of the captured card ID advertisement.

In combination with any of the above examples, the method may include activating a light to illuminate an area proximate to the smart card.

In combination with any of the above examples, the method may include detecting motion near a reader and instructing a camera to capture the card ID advertisement based on the detected motion.

In combination with any of the above examples, the method may include sending a signal to the smart card to activate a second pairing light, the second pairing light located on the smart card.

In combination with any of the above examples, the pairing light and the second pairing light may display corresponding light patterns.

### BRIEF DESCRIPTION OF THE DRAWINGS

The figures illustrate examples of systems and methods for a passive smart card and reader using ultra-wide band (UWB) communication.

FIG. 1 is a perspective view of a passive UWB smart card, according to examples of the present disclosure;

FIG. 2 illustrates a block diagram for a passive UWB smart card, according to examples of the present disclosure;

FIG. 3 illustrates a block diagram for a reader of a passive UWB smart card, according to examples of the present disclosure;

FIG. 4 illustrates a method performed for using a passive UWB smart card reader, according to examples of the present disclosure;

FIG. 5 illustrates a more detailed method performed for using a passive UWB smart card reader, according to examples of the present disclosure; and

FIG. 6 illustrates a method performed for using a passive UWB smart card, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, systems and methods for a passive smart card and reader using ultra-wide band (UWB) communication are provided. The passive UWB smart card may have the same or similar form factor as a conventional contactless smart card. The passive UWB smart card may be used for the same use cases as a conventional contactless smart card (e.g., payment such as EMVCo and cryptocurrencies, secure access, public transportation, ticketing, government identification such as ePass, eID, electronic driver's license, and electronic health cards), but allow for communications when the smart card further away from the reader (e.g., several meters away from the reader). For example, the passive UWB card may be in a car and communicate with a reader on a nearby building or gate. The passive UWB card may be secure against man-in-the-middle attacks and maintain communication with the reader after pairing, even when no longer in visible range of the reader.

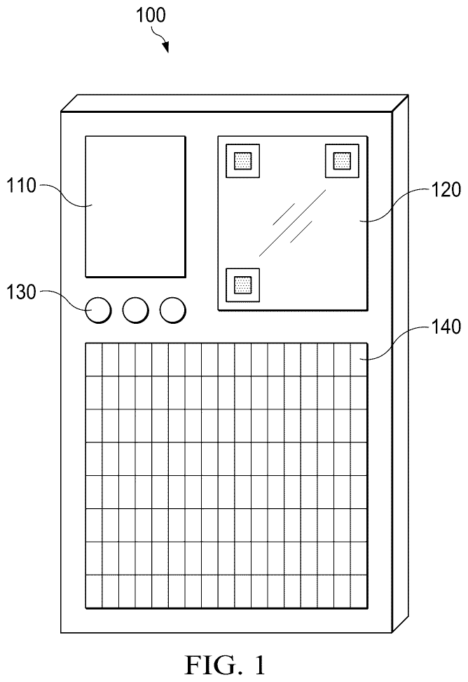

FIG. 1 is a perspective view of a passive UWB smart card, according to examples of the present disclosure. UWB smart card 100 may include contact pad 110, card ID advertisement 120, pairing lights 130, and solar cell 140.

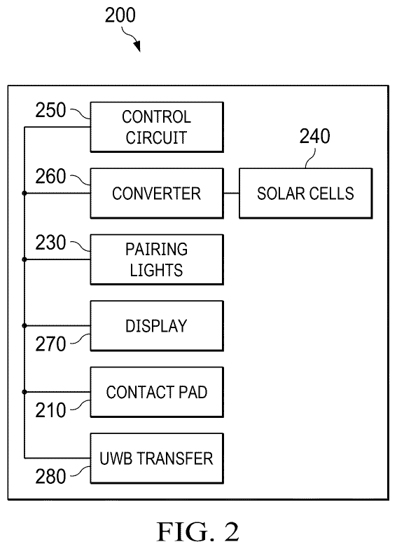

UWB smart card 100 may include a control circuit (shown in FIG. 2) to control the operations of the components of UWB smart card 100. The control circuit may be executing an operating system, such as Java Card OS, and applications to enable a use case, such as applets for payments or identification.

Contact pad 110 may indicate the presence of a user to enable the pairing process between UWB smart card 100 and a reader. Before contact pad 110 is engaged by the user, UWB smart card 100 may be in a passive state. After contact pad 110 is engaged, UWB smart card 100 may become active such that it may be paired with a reader. Contact pad 110 may be a fingerprint sensor, a capacitive pad, a resistive pad, button, or any other suitable contact to indicate user presence. In some examples, contact pad 110 may perform biometric authentication. For example, contact pad 110 may be a fingerprint sensor and the control circuit may analyze the fingerprint captured by the fingerprint sensor and compare the fingerprint to a stored fingerprint of an authorized user to confirm the user's identity. Contact pad 110 may have any suitable size and shape. For example, contact pad 110 may be a square with a size of 16 millimeters by 16 millimeters. If, at any point during the pairing process, the user wishes to abort the process, the user may stop contact with contact pad 110 to deactivate contact pad 110 and UWB smart card 100 may power off and return to a passive state. Deactivating contact pad 110 may deactivate a UWB transceiver in UWB smart card 100 to prevent further communications between UWB smart card 100 and the reader.

Card ID advertisement 120 may provide a visual indication of the card ID to enable UWB pairing between UWB smart card 100 and a reader. Card ID advertisement 120 may be a quick response (QR) code, bar code, text, signs, drawings, color pattern, or any other suitable code used to provide the card ID to the reader. Card ID advertisement 120 may have any suitable size or shape. For example, card ID advertisement 120 may be a 35 millimeter by 35-millimeter QR-type code with 37 customizable “bits” (e.g., black or white dots). This equates to approximately 137 billion possible unique IDs. In some examples, some “bits” may be reserved for image recognition. Card ID advertisement 120 may be static (e.g., printed on a surface of UWB smart card 100) or dynamic (e.g., provided via display). In examples where card ID advertisement 120 is dynamic, card ID advertisement 120 may be the same each time UWB smart card 100 is activated or card ID advertisement 120 may change each time UWB smart card 100 is activated (e.g., display a first card ID advertisement at a first time and a second card ID advertisement at a second time). Any suitable display may be used to display a dynamic card ID advertisement 120, such as an electronic ink (e-ink), liquid crystal display (LCD), or light-emitting diode (LED) display. In some examples, the display may be a display formed of infrared LEDs such that the information displayed on the display is not visible by the naked eye.

Pairing lights 130 may be one or more lights to display a light pattern or color during the pairing process. Pairing lights 130 may be any suitable type of lights, such as LED lights. In examples using a dynamic card ID advertisement, the same display used to display the dynamic card ID advertisement may be used to display pairing lights 130. When UWB smart card 100 is pairing with a reader, pairing lights 130 may display a color pattern or blinking pattern. The reader may also have lights and may display a color pattern or blinking pattern. The user of UWB smart card 100 may ensure that pairing lights 130 and the lights on the reader display a corresponding light pattern to ensure that UWB smart card 100 is pairing with the intended reader. If the pairing lights do not display the corresponding light pattern, the user may stop contact with contact pad 110 such that UWB smart card 100 does not pair with the reader. This verification may eliminate or reduce the potential for man-in-the-middle attacks.

Solar cell 140 may provide power to the components of UWB smart card 100. The components of UWB smart card 100 may remain passive until solar cell 140 is activated. In some examples, solar cell 140 may be replaced by, or used in addition to, a battery, NFC-based power source, or contact-based power source (e.g., universal serial bus (USB)). While solar cell 140 is shown on the front of UWB smart card 100 in FIG. 1, solar cell 140 may be located on any suitable location of UWB smart card 100. The placement of solar cell 140 may allow more space for other components of UWB smart card 100. For example, if solar cell 140 is placed on the back of UWB smart card 100, card ID advertisement 120 may be larger. Additionally, while solar cell 140 is shown as having a size of approximately 50% of UWB smart card 100, solar cell 140 may have any suitable size to generate sufficient power to power the components of UWB smart card 100. In some examples, UWB smart card 100 may include a flat capacitor to store extra energy.

UWB smart card 100 may use UWB to communicate with the reader. In some examples, UWB smart card 100 may also include a contact-based interface, such as ISO7816-3, such that UWB smart card 100 may also communicate with conventional smart card readers. In some examples, UWB smart card 100 may be paired with a smart wearable (e.g., a smart phone or tablet) to perform administrative level tasks, such as locking UWB smart card 100 or registering a new fingerprint. In these examples, the smart wearable may include an application to manage UWB smart card 100.

FIG. 2 illustrates a block diagram for a passive UWB smart card, according to examples of the present disclosure. UWB smart card 200 may be similar to UWB smart card 100 shown in FIG. 1 and may include contact pad 210, pairing lights 230, solar cell 240, control circuit 250, converter 260, display 270, and UWB transceiver 280.

Contact pad 210 may be similar to contact pad 110 shown in FIG. 1 and may indicate the presence of a user to enable the pairing process between UWB smart card 200 and a reader. Contact pad 210 may be a fingerprint sensor, a capacitive pad, a resistive pad, button, or any other suitable contact to indicate user presence. In some examples, contact pad 210 may perform biometric authentication and control circuit 250 may analyze the fingerprint captured by the fingerprint sensor to confirm the user's identity.

Pairing lights 230 may be similar to pairing lights 130 shown in FIG. 1 and may be one or more lights to display a light pattern or color during the pairing process. Pairing lights 230 may be any suitable type of lights, such as LED lights. In some examples, UWB smart card 200 may not include pairing lights 230 and display 270 may be used to display the light pattern during the pairing process.

Solar cell 240 may be similar to solar cell 140 shown in FIG. 1 and may provide power to the components of UWB smart card 200. The components of UWB smart card 200 may remain passive until solar cell 240 is activated by a user engaging with contact pad 210.

Control circuit 250 may be a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. Control circuit 250 control the operations of the components of UWB smart card 200, such as, but not limited to, the illumination pattern of pairing lights 230, the card ID advertisement shown on display 270, communication using UWB transceiver 280. Control circuit 250 may execute an operating system, such as Java Card OS, and applications to enable a use case, such as applets for payments or identification.

Converter 260 may receive power from solar cell 240 and convert the power from solar cell 240 to a voltage that may be used to power the components of UWB smart card 200. For example, converter 260 may be a DC-to-DC converter.

Display 270 may be any suitable display, such as but not limited to an electronic ink (e-ink), liquid crystal display (LCD), or light-emitting diode (LED) display, for providing a dynamic card ID advertisement. In some examples, display 270 may be a display formed of infrared LEDs such that the information displayed on display 270 is not visible by the naked eye. The card ID advertisement shown in display 270 may be used for the same purpose as card ID advertisement 120 shown in FIG. 1. In examples using a static card ID advertisement, display 270 may not be present in UWB smart card 200.

UWB transceiver 280 may communicate with a reader during the pairing process and then to exchange information, such as payment or identification information.

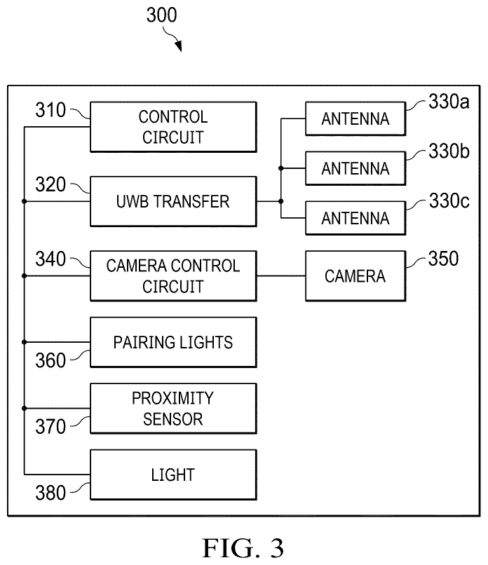

FIG. 3 illustrates a block diagram for a reader of a passive UWB smart card, according to examples of the present disclosure. Reader 300 may include control circuit 310, UWB transceiver 320, UWB antennas 330a, 330b, and 330c, camera control circuit 340, camera 350, pairing lights 360, proximity sensor 370, and light 380.

Control circuit 310 may be a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. Control circuit 310 control the operations of the components of reader 300, such as, but not limited to, the illumination pattern of pairing lights 360, communication using UWB transceiver 320, activating light 380, controlling camera 350 via camera control circuit 340, and interpreting a signal from proximity sensor 370. Control circuit 310 may execute an operating system and applications to enable a use case, such as applets for payments or identification. Control circuit 310 may execute applications similar to a conventional smart card reader to provide payment, access, or identification services.

UWB transceiver 320 may communicate with a UWB smart card during the pairing process and to exchange information, such as payment or identification information. UWB transceiver 320 may use at least three UWB antennas 330a, 330b, and 330c to enable reader 300 to triangulate the location of the UWB smart card. Reader 300 may use the triangulated location of the UWB smart card to verify that the triangulated location corresponds to the location of the card ID advertisement captured by camera 350.

Camera control circuit 340 may control camera 350. Camera 350 may capture an image of a card ID advertisement and provide that information to control circuit 310 for decoding. In addition to capturing an image of a card ID advertisement, camera 350 may capture images of the environment around reader 300. In some examples, camera 350 may perform video recording in addition to still image capture.

Pairing lights 360 may be one or more lights to display a light pattern or color during the pairing process. Pairing lights 360 may be any suitable type of lights, such as LED lights. When reader 300 is pairing with a UWB smart card, pairing lights 360 may display a color pattern or blinking pattern. As described with respect to FIGS. 1 and 2, the UWB smart card may also have pairing lights and may display a color pattern or blinking pattern. The user of the UWB smart card may ensure that pairing lights 360 and the pairing lights on the UWB smart card display a corresponding light pattern to ensure that reader 300 is pairing with the UWB smart card. This verification may eliminate or reduce the potential for man-in-the-middle attacks.

Proximity sensor 370 may detect movement near reader 300 and activate components of reader 300 such as camera 350 or light 380 such that reader 300 is ready to begin pairing with a UWB smart card.

Light 380 may provide a light source to power a UWB smart card, such as providing light to activate solar cell 140 shown in FIG. 1. Control circuit 310 may direct light 380 to an area proximate to where the UWB smart card may be present to illuminate the area. In some examples, if sufficient ambient light exists to power the UWB smart card, light 380 may not be used. Light 380 may also enhance the image capturing ability of camera 350 by illuminating the card ID advertisement.

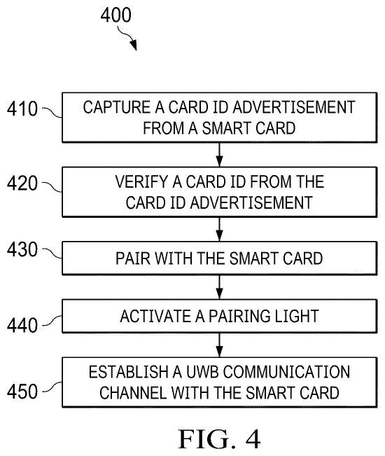

FIG. 4 illustrates a method performed for using a passive UWB smart card reader, according to examples of the present disclosure. Method 400 may be implemented using a reader (e.g., reader 300 shown in FIG. 3), in combination with a processor, or any other system operable to implement method 400. Although examples have been described above, other variations and examples may be made from this disclosure without departing from the spirit and scope of these disclosed examples.

Method 400 may begin at block 410 where the reader may capture a card ID advertisement from a UWB smart card. The reader may use a camera, such as camera 350 shown in FIG. 3, to capture the card ID advertisement, such as card ID advertisement 120 shown in FIG. 1 or a card ID advertisement displayed on display 270 shown in FIG. 2.

At block 420, a control circuit in the reader may verify the card ID. The control circuit may extract the card ID from the card ID advertisement captured at block 410. To verify the card ID, the control circuit may, for example, compare the card ID to a list of approved IDs in a database. If the card ID is on the list of approved IDs, the control circuit may proceed with the pairing process. If the card ID is not on the list of approved IDs, the control circuit may end the pairing process. In examples where the card ID advertisement is dynamically generated, the control circuit may decrypt the dynamic card ID advertisement. The control circuit may compare the decrypted dynamic card ID advertisement against a hash or by following an application-driven calculation formula. Additionally, a dynamically generated card ID advertisement may include or encode context driven information, such as, but not limited to, geolocation data or card movement pattern data. As an example of card movement pattern data, a user of the UWB smart card may shake the UWB smart card to limit a payment transaction to a maximum amount (e.g., $10.00).

At block 430, the control circuit in the reader may perform the pairing process between the reader and the UWB smart card. The pairing process may include establishing an encrypted communication channel.

At block 440, the control circuit in the reader may activate one or more pairing lights on the reader, such as pairing lights 360 shown in FIG. 3. The control circuit may also send a signal to the UWB smart card to activate pairing lights on the UWB smart card, such as pairing lights 130 or 230 shown in FIGS. 1 and 2, respectively. The control circuit may instruct the UWB smart card to activate the pairing lights on the UWB smart card to display a corresponding light pattern as the light pattern displayed on the pairing lights on the reader. In some examples, the control circuit may activate a display on the UWB smart card, such as display 270 shown in FIG. 2, to display the light pattern during the pairing process. The user of the UWB smart card may ensure that the pairing lights on both the UWB smart card and the reader display the same pattern to ensure that the UWB smart card is pairing with the intended reader. If the pairing lights do not display the corresponding light pattern, the user may stop contact with the contact pad such that the UWB smart card does not pair with the reader. This verification may eliminate or reduce the potential for man-in-the-middle attacks.

At block 450, the control circuit in the reader may establish a UWB communication channel with the UWB smart card. In some examples, the UWB communication channel may be a secure communication channel.

Although FIG. 4 discloses a particular number of operations related to method 400, method 400 may be executed with greater or fewer operations than those depicted in FIG. 4. In addition, although FIG. 4 discloses a certain order of operations to be taken with respect to method 400, the operations comprising method 400 may be completed in any suitable order.

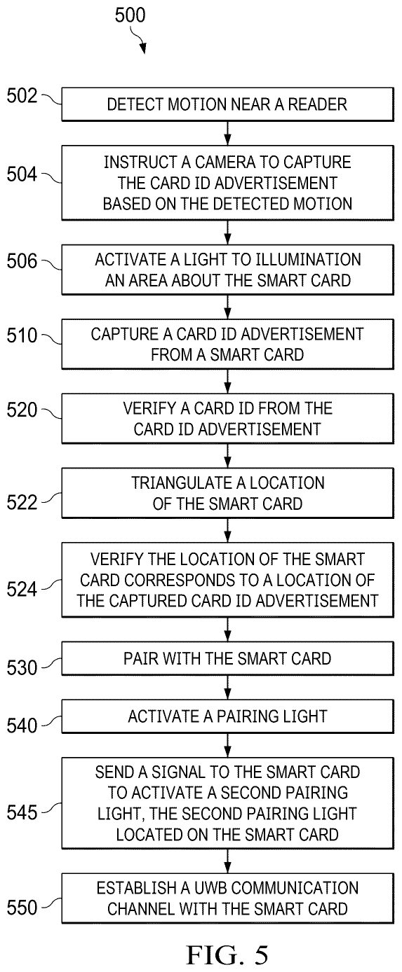

FIG. 5 illustrates a more detailed method performed for using a passive UWB smart card reader, according to examples of the present disclosure. Method 500 may be implemented using a reader (e.g., reader 300 shown in FIG. 3), in combination with a processor, or any other system operable to implement method 500. Although examples have been described above, other variations and examples may be made from this disclosure without departing from the spirit and scope of these disclosed examples.

Method 500 may begin at block 502 where the control circuit may detect motion near a reader. The detection of motion near the reader may indicate the presence of a user near the reader. The control circuit may use a signal from an image recognition camera, such as camera 350 shown in FIG. 3, or a proximity sensor, such as proximity sensor 370 shown in FIG. 3, or any combination thereof to detect user presence.

At block 504, the control circuit may instruct a camera to capture a card ID advertisement on a UWB smart card based on the motion detected at block 502.

At block 506, the control circuit may activate a light, such as light 380 shown in FIG. 3, to shine the light on the area proximate to where the motion was detected. The light may illuminate the area proximate to where the motion was detected. In some examples, the control circuit may determine whether sufficient ambient light exists and activate the light based on the determination that insufficient ambient light is present. The light may be used to power the UWB smart card.

At block 510, the control circuit may capture a card ID advertisement from a UWB smart card. The reader may use a camera, such as camera 350 shown in FIG. 3, to capture the card ID advertisement, such as card ID advertisement 120 shown in FIG. 1 or a card ID advertisement displayed on display 270 shown in FIG. 2.

At block 520, a control circuit in the reader may verify the card ID. The control circuit may extract the card ID from the card ID advertisement captured at block 510. To verify the card ID, the control circuit may, for example, compare the card ID to a list of approved IDs in a database. If the card ID is on the list of approved IDs, the control circuit may proceed with the pairing process. If the card ID is not on the list of approved IDs, the control circuit may end the pairing process. In examples where the card ID advertisement is dynamically generated, the control circuit may decrypt the dynamic card ID advertisement. The control circuit may compare the decrypted dynamic card ID advertisement against a hash or by following an application-driven calculation formula. Additionally, a dynamically generated card ID advertisement may include or encode context driven information, such as, but not limited to, geolocation data or card movement pattern data. As an example of card movement pattern data, a user of the UWB smart card may shake the UWB smart card to limit a payment transaction to a maximum amount (e.g., $10.00).

At block 522, the control circuit may triangulate the location of the UWB smart card. The control circuit may triangulate the location of the UWB smart card based on the signal strength from UWB antennas 330a, 330b, and 330c shown in FIG. 3. At block 524, the control circuit may verify the location of the UWB smart card, as determined at block 522, corresponds to the location of the card ID advertisement, captured at block 510. The control circuit may perform the verification to ensure that the UWB smart card is within the field of vision of the camera. The verification may reduce or eliminate the potential for man-in-the-middle attacks.

At block 530, the control circuit in the reader may perform the pairing process between the reader and the UWB smart card. The pairing process may include establishing an encrypted communication channel.

At block 540, the control circuit in the reader may activate one or more pairing lights on the reader, such as pairing lights 360 shown in FIG. 3. The control circuit may also send a signal to the UWB smart card to activate pairing lights on the UWB smart card, such as pairing lights 130 or 230 shown in FIGS. 1 and 2, respectively. The control circuit may instruct the UWB smart card to activate the pairing lights on the UWB smart card to display the corresponding light pattern as the light pattern displayed on the pairing lights on the reader. The user of the UWB smart card may ensure that the pairing lights on both the UWB smart card and the reader display the same pattern to ensure that the UWB smart card is pairing with the intended reader. If the pairing lights do not display the same pattern, the user may stop contact with the contact pad such that the UWB smart card does not pair with the reader. This verification may eliminate or reduce the potential for man-in-the-middle attacks.

At block 545, the control circuit may also send a signal to the UWB smart card to activate a second pairing light on the UWB smart card, such as pairing lights 130 or 230 shown in FIGS. 1 and 2, respectively. The control circuit may instruct the UWB smart card to activate the pairing lights on the UWB smart card to display the corresponding light pattern as the light pattern displayed on the pairing lights on the reader at block 540. In some examples, the control circuit may activate a display on the UWB smart card, such as display 270 shown in FIG. 2, to display the light pattern during the pairing process. The user of the UWB smart card may ensure that the pairing lights on both the UWB smart card and the reader display the same pattern to ensure that the UWB smart card is pairing with the intended reader. If the pairing lights do not display the same pattern, the user may stop contact with the contact pad such that the UWB smart card does not pair with the reader. This verification may eliminate or reduce the potential for man-in-the-middle attacks.

At block 550, the control circuit in the reader may establish a UWB communication channel with the UWB smart card. In some examples, the UWB communication channel may be a secure communication channel.

Although FIG. 5 discloses a particular number of operations related to method 500, method 500 may be executed with greater or fewer operations than those depicted in FIG. 5. In addition, although FIG. 5 discloses a certain order of operations to be taken with respect to method 500, the operations comprising method 500 may be completed in any suitable order.

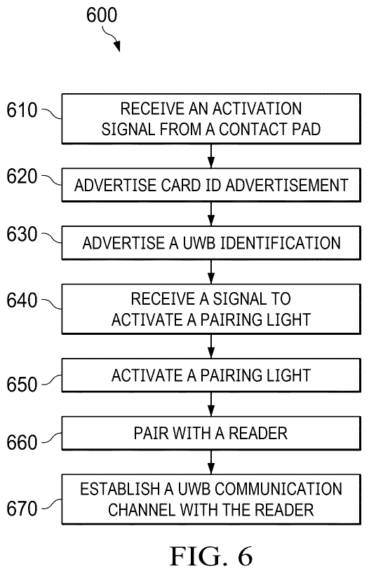

FIG. 6 illustrates a method performed for using a passive UWB smart card, according to examples of the present disclosure. Method 600 may be implemented using a 6 a passive UWB smart card (e.g., UWB smart card 100 or 200 shown in FIGS. 1 and 2, respectively), in combination with a processor, or any other system operable to implement method 600. Although examples have been described above, other variations and examples may be made from this disclosure without departing from the spirit and scope of these disclosed examples.

Method 600 may begin at block 610 where a control circuit may receive an activation signal from a contact pad on a UWB smart card, such as contact pad 110 or 210 shown in FIGS. 1 and 2, respectively. The engagement signal may be transmitted to the control circuit when a user enables a UWB smart card. To enable the UWB smart card, the user may present the card and make contact with the contact pad to enable the UWB smart card. A solar cell, such as solar cell 140 shown in FIG. 1, may power the UWB smart card. In some examples, the contact pad may be a fingerprint reader and the UWB smart card may authorize the user based on the user's fingerprint.

At block 620, the control circuit may advertise the card ID advertisement. The control circuit may advertise the card ID advertisement by sending a signal to a display, such as display 270 shown in FIG. 2, to cause the display to present the card ID advertisement. In examples where the UWB smart card includes a static card ID advertisement printed on the card, block 620 may not be performed.

At block 630, the control circuit may begin advertising its UWB identification (ID) to wait for UWB pairing. A reader may capture the UWB identification to begin the pairing process between the reader and the UWB smart card.

At block 640, the control circuit may also receive a signal to activate one or more pairing lights, such as pairing lights 130 or 230 shown in FIGS. 1 and 2, respectively. The signal may instruct the control circuit to display the corresponding light pattern as the light pattern displayed on the pairing lights on the reader. In some examples, the control circuit may activate a display on the UWB smart card, such as display 270 shown in FIG. 2, to display the light pattern during the pairing process.

At block 650, the control circuit may activate the one or more pairing lights. The user of the UWB smart card may ensure that the pairing lights on both the UWB smart card and the reader display the same pattern to ensure that the UWB smart card is pairing with the intended reader. If the pairing lights do not display the same pattern, the user may stop contact with the contact pad such that the UWB smart card does not pair with the reader. This verification may eliminate or reduce the potential for man-in-the-middle attacks.

### At Block 660, the Control Circuit May Pair With the Reader.

At block 670, the control circuit may establish a UWB communication channel with the reader. In some examples, the UWB communication channel may be a secure communication channel.

Although FIG. 6 discloses a particular number of operations related to method 600, method 600 may be executed with greater or fewer operations than those depicted in FIG. 6. In addition, although FIG. 6 discloses a certain order of operations to be taken with respect to method 600, the operations comprising method 600 may be completed in any suitable order.

Although examples have been described above, other variations and examples may be made from this disclosure without departing from the spirit and scope of these disclosed examples.

1. An apparatus, comprising:
a contact pad;
a pairing light;
an ultra-wide band (UWB) transceiver; and
a control circuit, the control circuit to:
activate the UWB transceiver when the contact pad is activated by a user;
activate the pairing light to display a light pattern during a pairing process between the UWB transceiver and a UWB transceiver on a reader; and
establish a UWB communication channel with the reader.

2. The apparatus of claim 1, comprising a solar cell to power the control circuit.

3. The apparatus of claim 1, comprising a card ID advertisement displayed on a surface.

4. The apparatus of claim 1, comprising:
a display;
wherein the control circuit is to display, using the display, a first card ID advertisement at a first time and a second card ID advertisement at a second time.

5. The apparatus of claim 1, wherein the control circuit is to receive a signal from the reader indicating the light pattern to display; and
wherein the light pattern to display corresponds to a second light pattern displayed on the reader.

6. The apparatus of claim 1, wherein the control circuit is to deactivate the UWB transceiver when the contact pad is deactivated by the user.

7. An apparatus, comprising:
a control circuit in a reader, the control circuit to:
instruct a camera to capture a card ID advertisement from a smart card;
verify a card ID from the card ID advertisement;
pair with the smart card using an ultra-wide band (UWB) transceiver;
activate a pairing light on the reader to display a light pattern when pairing the UWB transceiver and a UWB transceiver on the smart card; and
establish a UWB communication channel with the smart card.

8. The apparatus of claim 7, wherein the control circuit is to:
triangulate a location of the smart card based on signal strength from a UWB antenna; and
verify the location of the smart card corresponds to a location of the captured card ID advertisement.

9. The apparatus of claim 8, wherein the control circuit is to verify the location of the smart card corresponds to a location of the captured card ID advertisement.

10. The apparatus of claim 7, wherein the control circuit is to activate a light to illuminate an area proximate to the smart card.

11. The apparatus of claim 10, wherein the control circuit is to detect the smart card and activate the light based on the detection.

12. The apparatus of claim 7, wherein the control circuit is to instruct the camera to capture the card ID advertisement based on a motion detected by a proximity sensor.

13. The apparatus of claim 7, wherein the control circuit is to send a signal to the smart card to activate a second pairing light, the second pairing light located on the smart card.

14. The apparatus of claim 13, wherein the pairing light and the second pairing light display corresponding light patterns.

15. A method, comprising:
capturing a card ID advertisement from a smart card;
verifying a card ID from the card ID advertisement;
pairing with the smart card;
activating a pairing light on a reader to display a light pattern when pairing the reader with the smart card; and
establishing a UWB communication channel with the smart card.

16. The method of claim 15, comprising:
triangulating a location of the smart card; and
verifying the location of the smart card corresponds to a location of the captured card ID advertisement.

17. The method of claim 15, comprising activating a light to illuminate an area proximate to the smart card.

18. The method of claim 15, comprising:
detecting motion near a reader; and
instructing a camera to capture the card ID advertisement based on the detected motion.

19. The method of claim 15, comprising sending a signal to the smart card to activate a second pairing light, the second pairing light located on the smart card.

20. The method of claim 19, wherein the pairing light and the second pairing light display corresponding light patterns.
